(19) United States
(12) Patent Application Publication
(10) Pub. No.: US 2008/0040363 A1
(43) Pub. Date: Feb. 14, 2008

(54) System for Processing Relational Database Data

(75) Inventor: Margaret Tauscher, Downingtown, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS USA, INC., Malvern, PA (US)

(21) Appl. No.: 11/771,283

(22) Filed: Jun. 29, 2007

Related U.S. Application Data
(60) Provisional application No. 60/807,212, filed on Jul. 13, 2006.

(51) Int. Cl. G06F 17/30

(52) U.S. Cl. 707/100; 707/E17.045

(57) ABSTRACT

A system assigns a branch number to each record derived from a database and generates XML using this branch number to sequence parent/child records so that output XML is nested properly, regardless of how many levels exist for each branch in order to organize a set of hierarchical data with an unknown tree depth and structure. A system processes hierarchically structured data in a relational database using a database processor. The database processor processes hierarchically structured data in a database to provide, a) a level identifier for an individual data item in the structured data indicating a level of hierarchy associated with the individual data item and b) a branch identifier indicating a sequential order of processing of the individual data item in the structured data. A data processor populates executable application data with multiple level and branch identifiers. The executable application is used for providing a representation of a structure of the hierarchically structured data.

This is a non-provisional application of provisional application Ser. No. 60/807,212 filed Jul. 13, 2006, by M. Tauscher.

### FIELD OF THE INVENTION

This invention concerns a system for processing hierarchically structured data in a relational database by populating executable application data with hierarchical level and branch identifiers to provide a representation of a structure of the hierarchically structured data.

### BACKGROUND OF THE INVENTION

Known systems fail to provide a consistent, efficient way to generate XML (Extensible Markup Language) data with an unknown number of nesting levels and unknown nesting complexity. Structured Query Language (SQL) provides commands to generate XML data from data in a relational database, but these commands do not work for complex tree structures. In known systems, in order to generate XML data from a SQL-based stored procedure, a “SELECT” statement is used to extract and format data. The “SELECT” statement consists of the data structure followed by “UNION” statements for the data. An SQL “ORDER BY” clause is needed to sequence the data. An “ORDER BY” clause for existing fields in an SQL “FOR XML” explicit function fails to provide the desired results since nesting levels vary for each branch. Consequently, much of a generated XML tree structure may not contain data. Also, the depth of levels in the generated data may not be fixed. Known systems fail to consistently and accurately display such a hierarchical tree properly. An SQL “ORDER BY” clause typically does not work on hierarchical data levels without data and an “ORDER BY” clause is limited to contain populated levels. Further, the ordering of data in a hierarchical structure changes depending on how data in a relational database is analyzed.

Known systems also involve storing XML data in a text field in a database but this is undesirable since it prevents querying the data by other executable applications using the same data. If the XML data is stored in a text field in the database, the ability to generate queries to be applied to the data is lost. Known systems are inefficient and cause an XML generation procedure to recompile and be slow when levels are not explicitly assigned and the ordering of XML data may change depending on analysis of system load and optimization. A system according to invention principles addresses these deficiencies and related problems.

### SUMMARY OF THE INVENTION

A system assigns a branch number to each record derived from a database and generates XML using this branch number to sequence records properly, regardless of how many levels exist for each branch in order to organize a set of hierarchical data with an unknown tree depth and structure. A system processes hierarchically structured data in a relational database using a database processor. The database processor processes hierarchically structured data in a database to provide, a) a level identifier for an individual data item in the structured data indicating a level of hierarchy associated with the individual data item and b) a branch identifier indicating a sequential order of processing of the individual data item in the structured data. A data processor populates executable application data with multiple level and branch identifiers. The executable application is used for providing a representation of a structure of the hierarchically structured data.

### BRIEF DESCRIPTION OF THE DRAWING

FIG. 1 shows a system for processing hierarchically structured data in a relational database, according to invention principles.

FIG. 2 shows a process for processing hierarchically structured data in a relational database by setting a hierarchical data tree structure branch identifier, according to invention principles.

FIG. 3 shows a hierarchical tree structure, according to invention principles.

FIG. 4 shows a format in a temporary table for storing data extracted from a database, according to invention principles.

FIG. 5 shows Branch Numbers in the temporary table of FIG. 4 initialized by setting them to zero, according to invention principles.

FIG. 6 shows Level and Branch identifiers in the temporary table of FIG. 5 set by the system, according to invention principles.

FIG. 7 illustrates Level/Branch Number assignments used to generate XML data, according to invention principles.

FIG. 8 shows sample source code to generate XML data using data in a temporary table by using the branch number to order the branches, according to invention principles.

FIG. 9 shows a flowchart of a process performed by the system for processing hierarchically structured data in a relational database, according to invention principles.

### DETAILED DESCRIPTION OF THE INVENTION

Hospitals use organization tree structures to group data. These tree structures have various numbers of branches and various depths to the tree structure branches. It is often necessary to represent these tree structures using eXtensible Markup Language (XML) an industry standard for representing data. When retrieving data having a varying depth tree structure from a database, it is necessary to order the parent/child records so that output XML data is nested properly. When a tree structure becomes large and multiple layers deep with varying depth, this becomes a problem. A system according to invention principles assigns a branch number to each record from the database. The output XML data representing nested parent and child records in a hierarchical tree structure is generated using this branch number to sequence the records properly, regardless of how many levels exist for each branch. Thereby the system addresses the problem of organizing a set of hierarchical data with an unknown tree depth and structure.

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor may comprise a combination of, hardware, firmware, and/or software.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A user interface (UI), as used herein, comprises one or more display images, generated by a display processor enabling user interaction with a processor or other device and associated data acquisition and processing functions. The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of the executable procedure or executable application manipulates the UI display images in response to the signals received from the input devices. In this way, the user interacts with the display image using the input devices, enabling user interaction with a processor or other device. The activities herein may be performed automatically or wholly or partially in response to user command. An automatically performed activity is performed in response to machine instruction or operation without direct user interaction in initiating the activity.

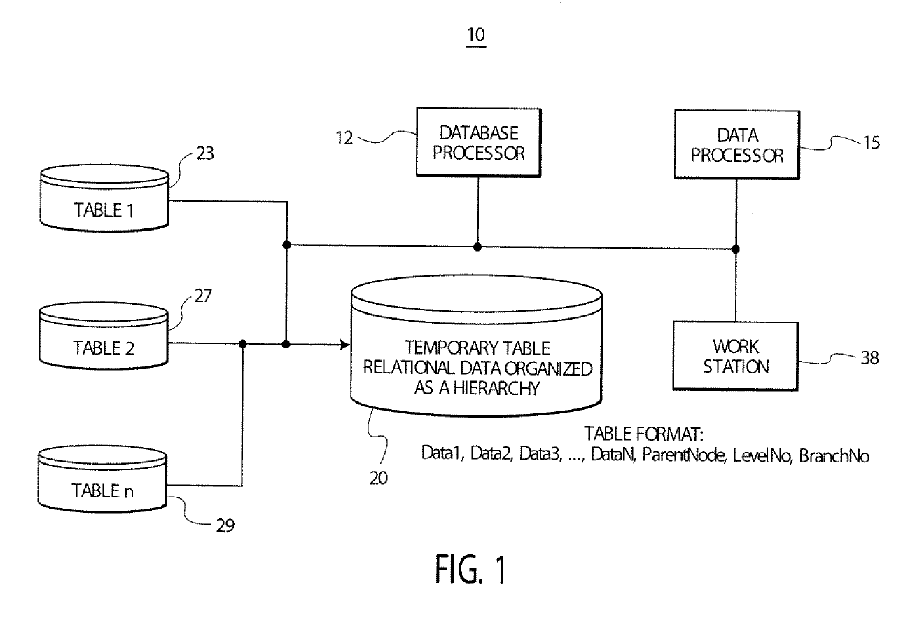

FIG. 1 shows system 10 for processing hierarchically structured data in a relational database. System 10 sequences relational database records that have a parent/child relationship without knowing the final nesting levels or the complexity of the nesting. This is useful for displaying a hospital organization chart or hospital data in a tree structure based on an XML format, for example. System 10 includes database processor 12, data processor 15, workstation 38 and database 20 (comprising tables 23, 27 and 29) linked via network 21. Database processor 12 processes hierarchically structured data in database 20 to provide, a) a level identifier for an individual data item in the structured data indicating a level of hierarchy associated with the individual data item and b) a branch identifier indicating a sequential order of processing of the individual data item in the structured data. Data processor 15 populates executable application data with multiple level and branch identifiers. The executable application is used for providing a representation of a structure of the hierarchically structured data for display on workstation 38.

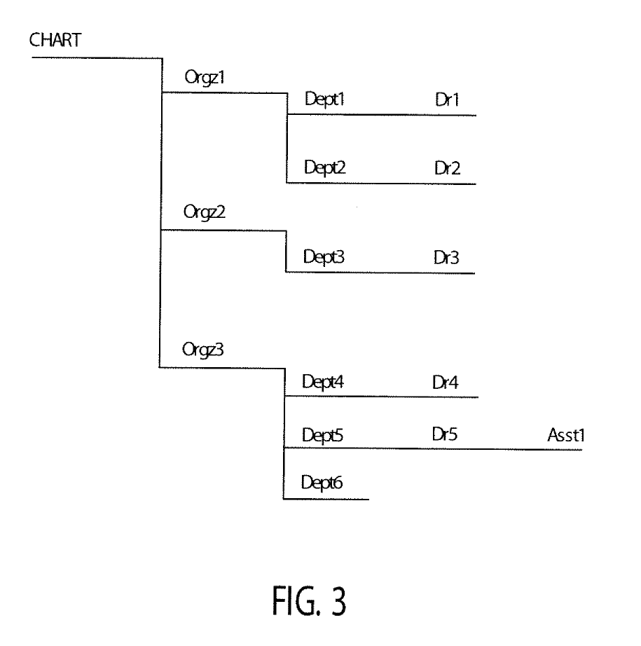

System 10 processes hierarchical data acquired from relational database 20 that is organized into a temporary table with columns for branch number and level. The hierarchical data has a parent/child record relationship that is controlled by a field containing a parent record name. In the diagrams below, the logical flow is described. Database processor 12 processes hierarchically structured data in database 20 by creating a temporary database table containing necessary organization information including parent node and additional Branch Number and Level Number fields. In this case, the Tables 23, 27 and 29 (Tables (1−n)) represent the types of data, Charts, Organizations, Departments, and Doctors. An individual entry contains information about a Parent record. FIG. 3 shows a hierarchical tree structure associated with the Charts, Organizations, Departments, Doctors and Assistants of Tables 23, 27 and 29.

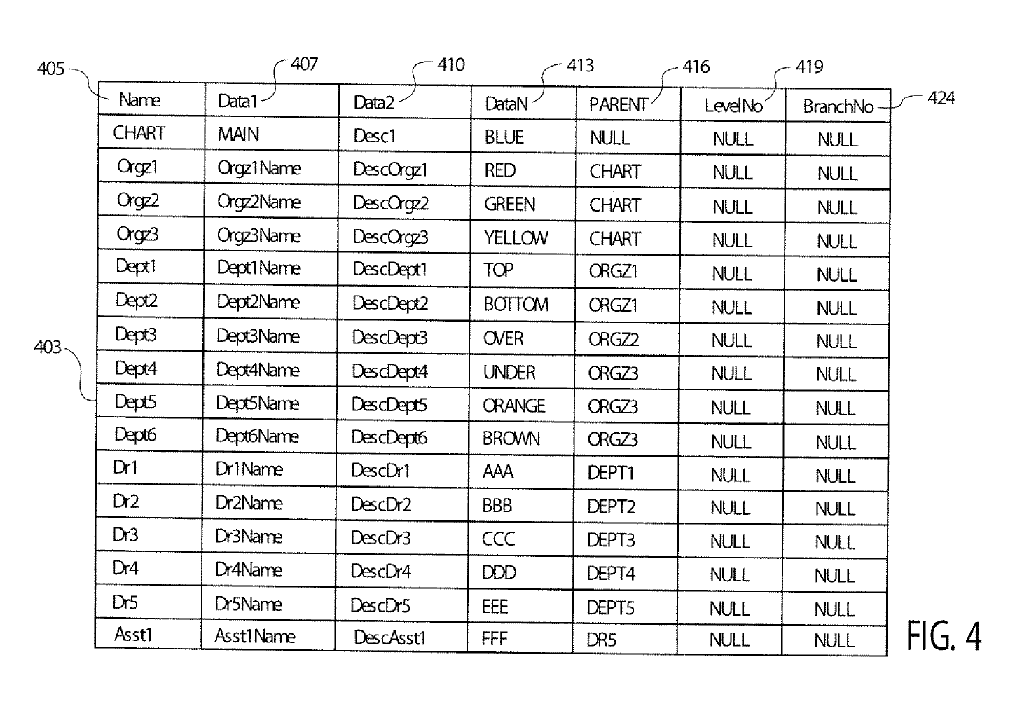

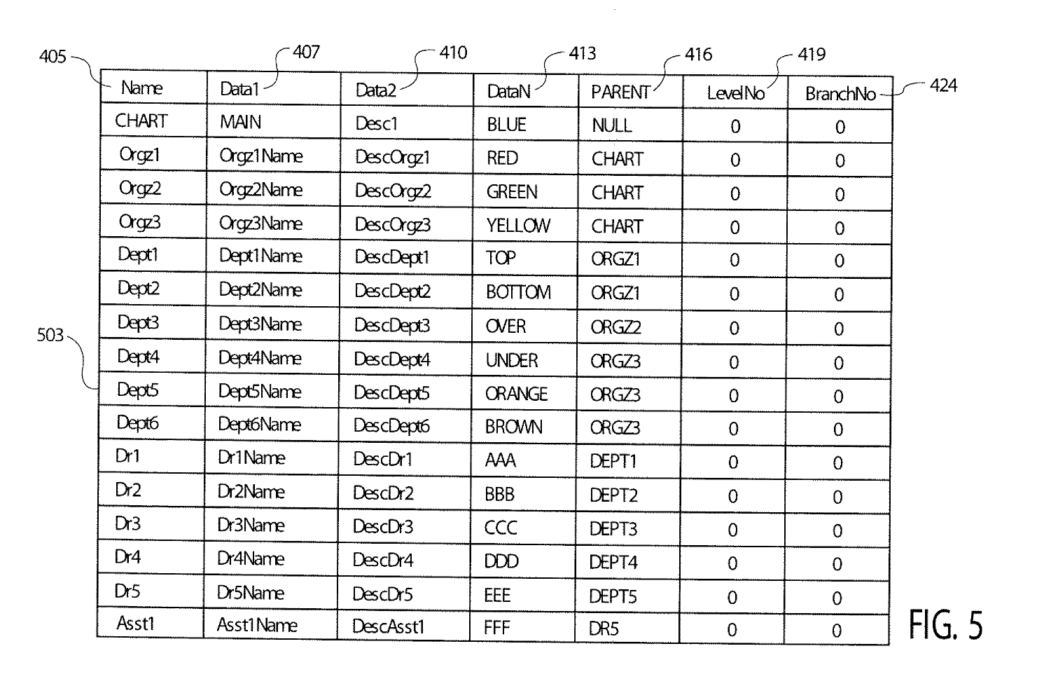

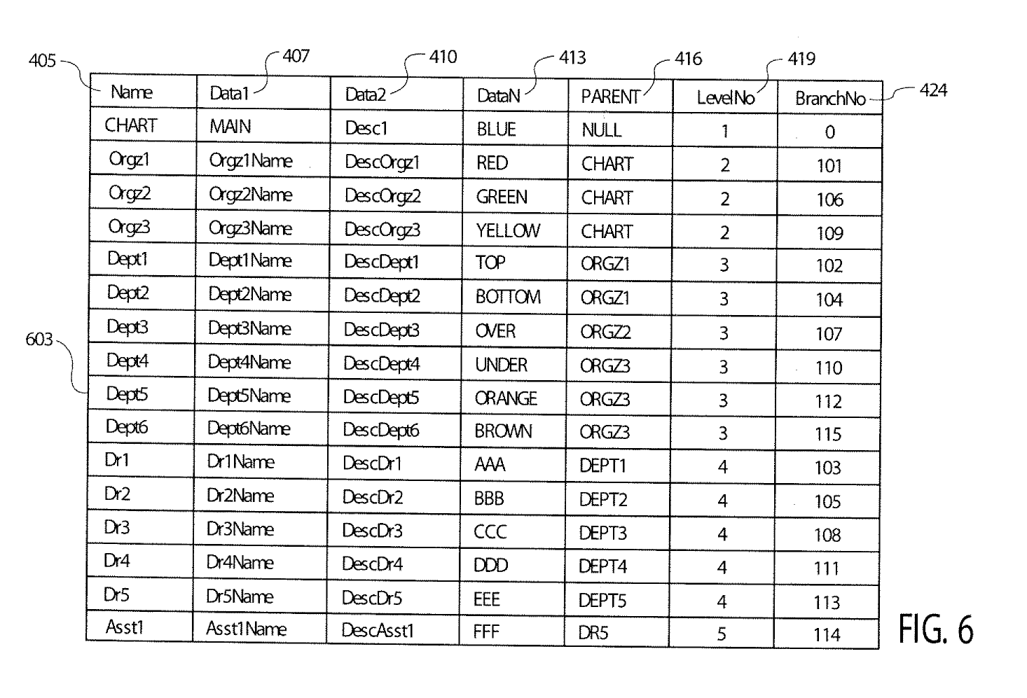

FIG. 4 shows a format in temporary database table 403 for storing data extracted from database 20. System 10 database processor 12 extracts data from database 20 representing the hierarchical tree structure of FIG. 3 into temporary database table 403. Data in table 403 includes, identifiers of record items of the structure sequentially ordered in column 405, corresponding record item names in column 407, corresponding record item descriptors in column 410, corresponding record item properties in column 413 and an identification of a parent record item of a record item in column 416. Columns 419 and 424 are for containing tree structure hierarchical level identifier and branch identifier respectively but these fields are null and not yet generated in table 403. FIG. 5 shows level identifier and branch identifier in columns 419 and 424 initialized to zero by database processor 12 in temporary table 503. FIG. 6 shows Level and Branch identifiers in columns 419 and 424 respectively of temporary table 603 set by system 10. Specifically, database processor 12 processes hierarchically structured data in database 20 to provide level identifiers for individual data items in column 419 of table 603 (FIG. 6) in the structured data indicating a level of hierarchy associated with the individual data item. Database processor 12 also processes hierarchically structured data in database 20 to provide branch identifiers in column 424 of table 603 indicating a sequential order of processing of individual data items in the structured data. Data processor 35 populates executable application data with the multiple level and branch identifiers.

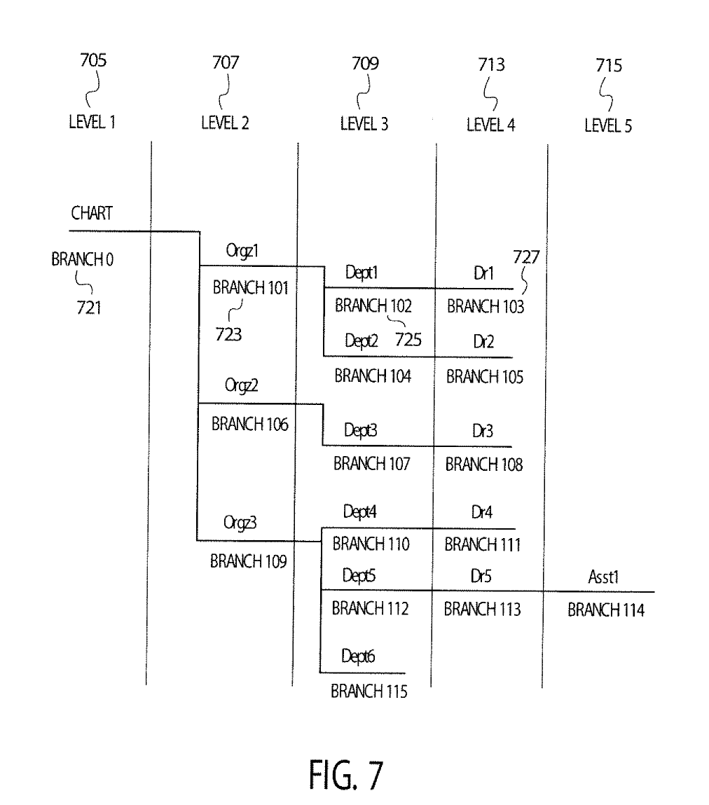

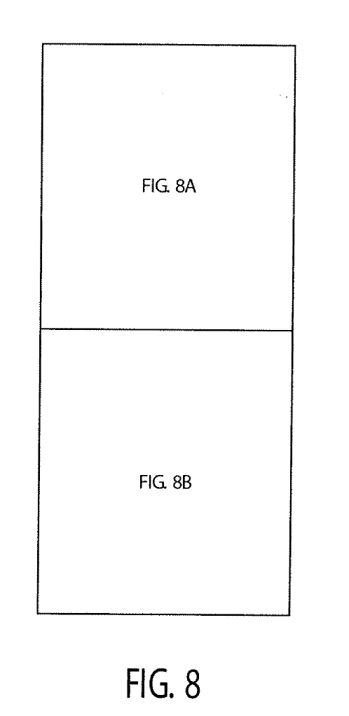

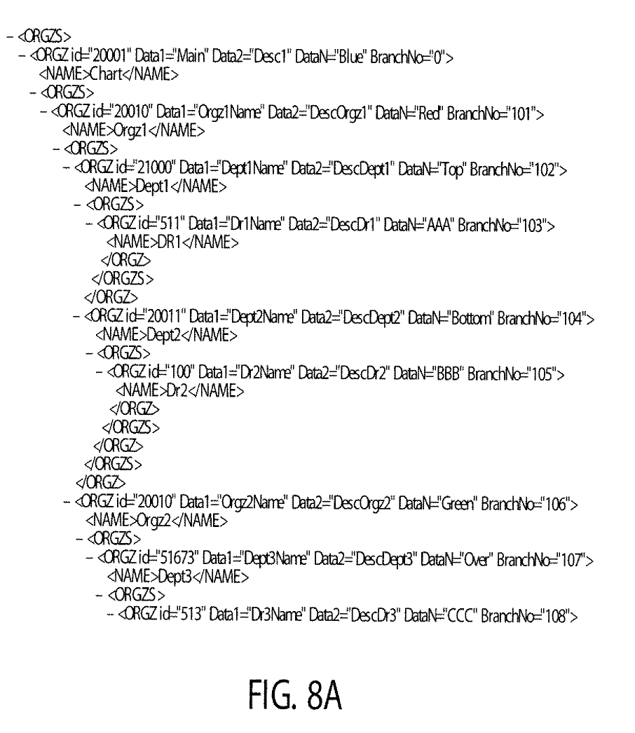

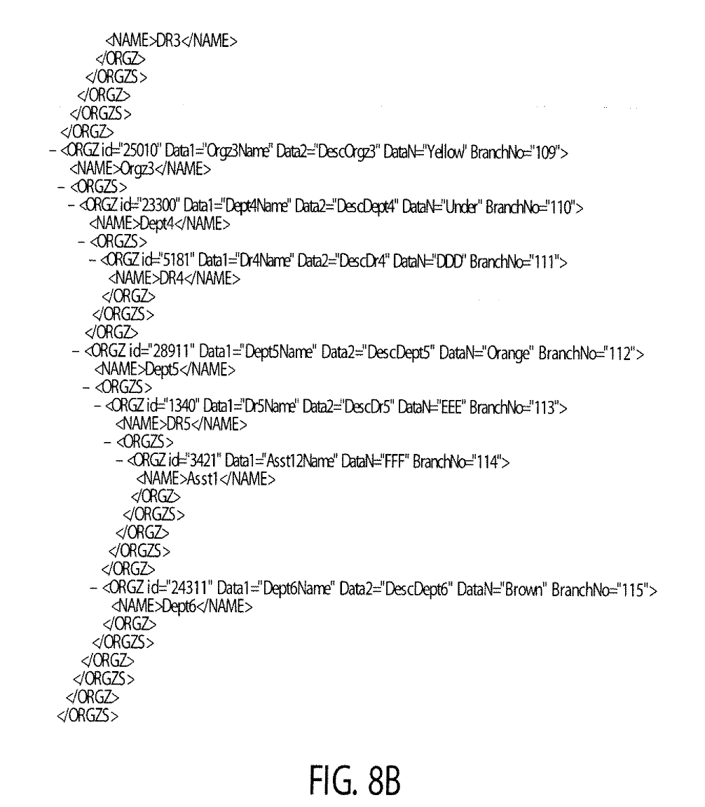

FIG. 7 illustrates Level and Branch identifier (e.g., number) assignments used to generate XML data representing the hierarchical structure represented in FIG. 3. Specifically, level identifiers (level 1, level 2, level 3, level 4, level 5) of column 419 (FIG. 6) are depicted in FIG. 7 (705, 707, 709, 713, 715). The branch identifiers, for example, include Branch 0 (721), Branch 101 (723), Branch 102 (725), Branch 103 (727). FIG. 8 shows sample source code to generate XML data using data in temporary table 603 by using the branch number to order the branches. Database processor 12 processes a record set in temporary table 603 in the database.

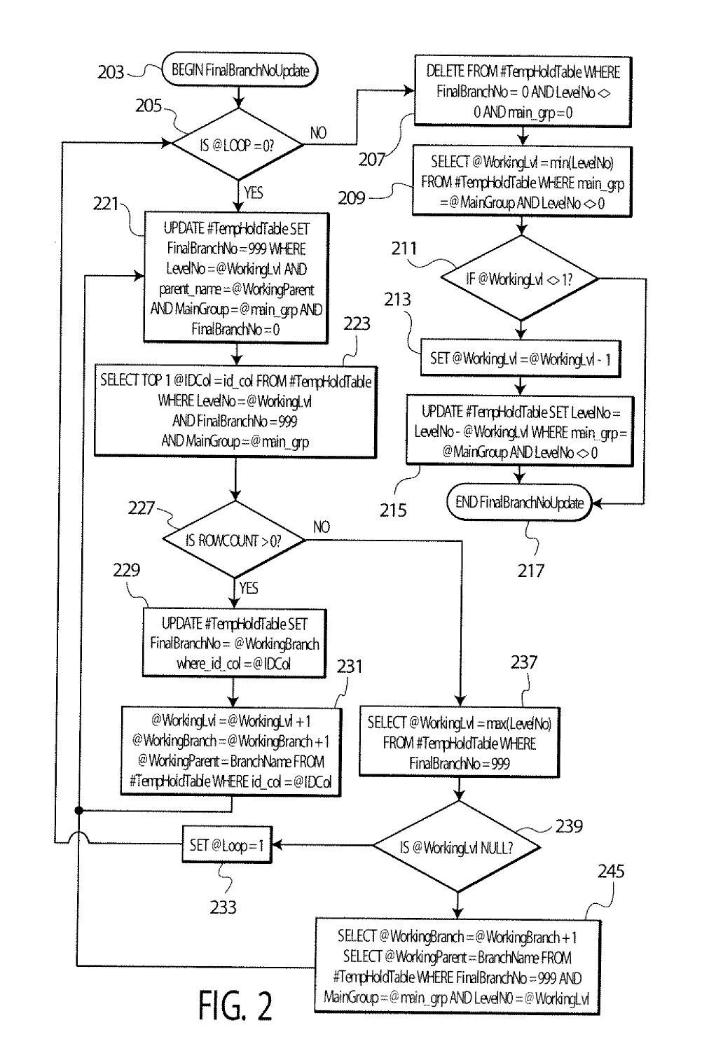

FIG. 2 shows a process employed by database processor 12 for processing hierarchically structured data in relational database 20 by setting a hierarchical data tree structure branch identifier in column 424 of table 603. Database processor 12 updates the branch number field of column 424 using the steps of FIG. 2 using an entry point corresponding to a highest level parent record. The FIG. 2 process uses a temporary table (e.g., table 503) created at the beginning of the process setting nesting and hierarchical levels. Database processor 12 advantageously assigns tree structure level identifiers without knowing how deep or complex a resulting XML tree will be from parent and child database records for creation of XML data containing Organization Charts, for example. The Level identifier of a record indicates the depth (or level) of record data to appear in the XML structure. In processing, the level is set to 1 for branches that have “Chart” as a parent. The first branch in level 1 is processed setting branches to level 2 that have a parent of the level 1 branch.

In FIG. 2, following the start at step 203 a loop counter is tested in step 205 to verify completion of the setup of branch and level numbers. Upon completion of this setup, steps 207, 209, 211, 213, 215 and 217 are used to clean up unused branches and reset the working levels if an entry point is specified at a working level other than 1. The branch identifiers (BranchNos) are being assigned in steps 221, 223, 227, 229, 231, 233, 237, 239 and 245. In steps 221 and 223, the first branch, “Chart” is given a BranchNo=0 and once the first level is assigned below the Chart, the first branch in level 1 is assigned a unique number. In step 221 rows are updated where a parent level equals a previous level to mark the rows with a particular parent. In step 223 it is determined if there is one row at that level that needs to be processed. In step 227 it is determined if there are no branches to be updated at this level and if there is a final branch number in other levels. In step 229 the branch number is updated. In step 231, information for the next branch is acquired. In step 237 it is determined if there are any other rows at the maximum level to update. In step 239 if it is determined all rows are processed, step 233 is performed. If all rows are not processed, information for processing the next branch is acquired in step 245. The starting number can be any positive number. Each BranchNo assigned in steps 237, 239 and 245 after this is the previous BranchNo plus 1. BranchNos are assigned one at a time, till reaching the end of the branch (indicated by the largest Level for the branch determined in step 237). At the end of the branch the system finds the first record with the largest Level and a Final BranchNo=999 (in this example) and begin the process of assigning BranchNo again. This is continued until branches from the entry point have a BranchNo. The BranchNo is used by system 10 in XML data processing to explicitly order records using a sequential numbering system that can start with any number. In step 207 any unused branches in the chart are removed. In step 209 (and steps 211-217) the working level is reassigned if the entry point is not at the top.

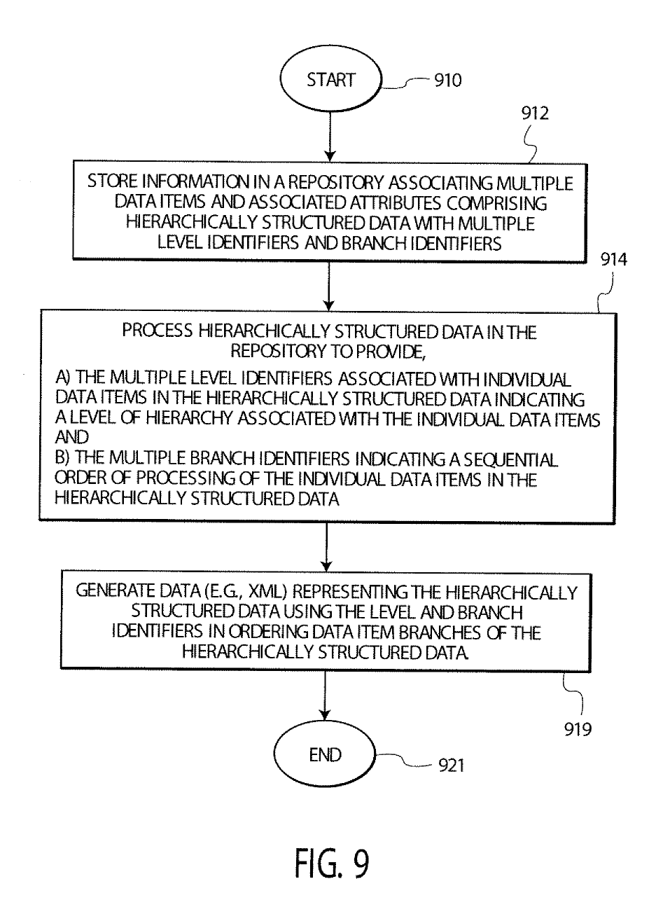

FIG. 9 shows a flowchart of a process performed by system 10 for processing hierarchically structured data in a relational database. The steps of FIG. 9 may be performed automatically except where identified as being exclusively manual. In step 912 following the start at step 910, database processor 12 stores information (e.g., executable application data) in repository 20 associating multiple data items and associated attributes comprising hierarchically structured data with multiple level identifiers and branch identifiers. This information is in temporary tables during processing and generation of the multiple level identifiers and branch identifiers. In step 914 database processor 12 processes hierarchically structured data in repository 20 to provide, a) the multiple level identifiers associated with individual data items (including an individual data item) in the hierarchically structured data indicating a level of hierarchy associated with the individual data items and b) the multiple branch identifiers indicating a sequential order of processing of the individual data items in the hierarchically structured data.

In step 919, data processor 15 generates data (e.g., XML data) representing the hierarchically structured data using the level and branch identifiers in ordering data item branches (and data items) of the hierarchically structured data. Data processor 15 thereby populates executable application (e.g., XML) data with multiple level and branch identifiers used for providing a representation of a structure of the hierarchically structured data. Data processor 15 processes the XML application using an XSL (Extensible Stylesheet Language) application in providing a displayable image presenting a tree structure of the hierarchically structured data on workstation 38 comprising the representation of the structure of the hierarchically structured data. The process of FIG. 9 terminates at step 921.

The system and processes of FIGS. 1-9 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. System 10 for processing hierarchically structured data in a relational database, is applicable to any system creating XML from database records with a parent/child relationship, where that relationship results in nested XML levels of various depths and number of branches. The processes and applications operating using network 21 (FIG. 1) may in alternative embodiments, be located on one or more (e.g., distributed) processing devices accessing the network shown in FIG. 1 or remotely accessible from this network. Further, any of the functions and steps provided in FIGS. 1-9 may be implemented in hardware, software or a combination of both and may reside on one or more processing devices located at any location of a network linking the FIG. 1 elements or another linked network including another intra-net or the Internet.

What is claimed is:

1. A system for processing hierarchically structured data in a relational database, comprising:
a database processor for processing hierarchically structured data in a repository to provide,
a) a level identifier for an individual data item in said structured data indicating a level of hierarchy associated with said individual data item and
b) a branch identifier indicating a sequential order of processing of said individual data item in said structured data; and
a data processor for populating executable application data with a plurality of level and branch identifiers, said executable application being used for providing a representation of a structure of said hierarchically structured data.

2. A system according to claim 1, wherein
said executable application is an XML (Extensible Markup Language) application.

3. A system according to claim 2, wherein
said XML application is processed by an XSL (Extensible Stylesheet Language) application in providing a displayable image presenting a tree structure of said hierarchically structured data comprising said representation of said structure of said hierarchically structured data.

4. A system according to claim 1, including
a repository of said executable application data comprising information associating a plurality of data items and associated attributes comprising said hierarchically structured data with said level identifier and said branch identifier.

5. A system according to claim 4, wherein
said information is stored in temporary tables.

6. A system according to claim 4, wherein
said data processor generates XML data representing said hierarchically structured data using said branch identifier in ordering data items of said hierarchically structured data.

7. A system according to claim 6, wherein
said data processor generates XML data representing said hierarchically structured data using said level identifier in ordering data items of said hierarchically structured data.

8. A system for processing hierarchically structured data in a relational database, comprising:
a database processor for processing hierarchically structured data in a repository to provide,
a) a plurality of level identifiers associated with individual data items in said hierarchically structured data indicating a level of hierarchy associated with said individual data items and
b) a plurality of branch identifiers indicating a sequential order of processing of said individual data items in said hierarchically structured data; and
a data processor for generating XML data representing said hierarchically structured data using said branch identifier in ordering data item branches of said hierarchically structured data.

9. A system according to claim 8, wherein
said data processor generates said XML data using said level identifier in ordering data item branches of said hierarchically structured data.

10. A system for processing hierarchically structured data in a relational database, comprising:
a repository of information associating a plurality of data items and associated attributes comprising hierarchically structured data with a plurality of level identifiers and branch identifiers.
a database processor for processing hierarchically structured data in said repository to provide,
a) said plurality of level identifiers associated with individual data items in said hierarchically structured data indicating a level of hierarchy associated with said individual data items and
b) said plurality of branch identifiers indicating a sequential order of processing of said individual data items in said hierarchically structured data; and
a data processor for generating data representing said hierarchically structured data using said level and branch identifiers in ordering data item branches of said hierarchically structured data.

11. A system according to claim 10, wherein
said data representing said hierarchically structured data comprises XML data.
